(19) United States
(12) Patent Application Publication
(10) Pub. No.: US 2021/0097539 A1
(43) Pub. Date: Apr. 1, 2021

(54) PROSPECTIVE DATA-DRIVEN SELF-ADAPTIVE SYSTEM FOR SECURING DIGITAL TRANSACTIONS OVER A NETWORK WITH INCOMPLETE INFORMATION

(71) Applicant: Microsoft Technology Licensing, LLC, Redmond, WA (US)

(72) Inventors: Jayaram N.M. Nanduri, Issaquah, WA (US); Yuting Jia, Redmond, WA (US); Anand Ravindra Oka, Bellevue, WA (US); Yung-Wen Liu, Redmond, WA (US); John A. Beaver, Kirkland, WA (US); Junxuan Li, Marietta, GA (US)

(21) Appl. No.: 16/587,930

(22) Filed: Sep. 30, 2019

(51) Int. Cl. G06Q 20/40; G06N 20/00

(52) U.S. Cl. CPC G06Q 20/401; G06N 20/00

(57) ABSTRACT

A system is described herein for managing digital transactions over a network with incomplete information. The system includes a data collection component and a transaction control component that may employ a prospective control model that is trained with fully matured data as well as partially matured data regarding past digital transactions. The transaction control component is configured to estimate an inauthentic rate of inauthentic digital transactions being wrongly approved for a current time period. A set of future reference values may be determined based on the estimated inauthentic rate. The set of future reference values relate to a predicted future decision made for the digital transaction. A set of current values may be determined based on the set of future reference values. Based on the set of current values, the transaction control component may determine whether the digital transaction should be rejected as inauthentic or approved as authentic.

### BACKGROUND

In a given day, millions of digital transactions may be processed by many computing devices and systems over one or more computer networks. Thus, it may be beneficial to create and maintain a secured network environment to process online or digital transactions, for example, to facilitate more approval of authentic digital transactions and fewer approval of inauthentic transactions.

Network security may include policies and practices to monitor and prevent misuse, unauthorized access, modification or denial of a computer network and its associated resources. Network security may include different levels of authentication, with a first level being the most basic and subsequent levels may build upon the previous ones. For example, a one-factor authentication may require a password to authenticate a user name. A two-factor authentication may require a password in addition to possession of an authenticating object (e.g., a security token or a mobile telephone). A three-factor authentication may require a password, an authenticating object, and a biometric characteristic of the user (e.g., a finger print or retinal scan). While these levels of authentication may decrease inauthentic digital transactions from bad actors, they also drive away good actors when they encounter such friction.

A security measure (e.g., security systems supported by machine learning with network traffic analysis, firewalls, intrusion detection and/or prevention systems) may be utilized to enforce security policies and practices, such as which services are allowed to be accessed by network users or which digital transactions initiated by network users may be approved, which ones may be rejected, and which ones may require further investigation.

One challenge in securing networks or securing digital transactions comes from the lack of complete information for the digital transactions. For example, at a given point in time, a percentage of data for the digital transactions may be fully-matured data (complete information), while another percentage of data may be partially-matured (incomplete information). Systems that utilize only complete information may not yield great decision accuracy for digital transactions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A system is described herein for managing digital transactions over a network.

The system includes a processing unit and a memory device coupled to the processing unit, the memory device storing program instructions for execution by the processing unit. The program instructions include a data collection component configured to collect data regarding a digital transaction. The program instructions further include a transaction control component configured to estimate an inauthentic rate of inauthentic digital transactions being wrongly approved for a current time period. A set of future reference values may be determined based on the estimated inauthentic rate. The set of future reference values relate to a predicted future decision made for the digital transaction. A set of current values may be determined based on the set of future reference values. Based on the set of current values for the digital transaction, the transaction control component may determine whether the digital transaction should be rejected as an inauthentic transaction or approved as an authentic transaction.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a decision flow of a digital transaction, according to an embodiment.

FIG. 2 depicts a life cycle of a payment of an online purchase, according to an embodiment.

FIG. 3 is a block diagram of a transaction management system, according to an embodiment.

FIG. 4 depicts a flow of a transaction control algorithm, according to an embodiment.

FIG. 5 depicts a decision flow of a prospective control algorithm, according to an embodiment.

FIG. 6 depicts logic of a real-time greedy heuristic, according to an embodiment.

FIG. 7 depicts a flowchart of a method for digital transaction management, according to an embodiment.

FIG. 8 depicts a flowchart of a refinement to the flowchart of FIG. 7 for classifying a digital transaction, according to an example embodiment.

FIG. 9 depicts a flowchart of a refinement to the flowchart of FIG. 7 that includes a feedback loop for a transaction control model, according to an example embodiment.

FIG. 10 depicts a flowchart of a refinement to the flowchart of FIG. 7 for determining a set of current values, according to an example embodiment.

FIG. 11 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

As used herein, an authentic digital transaction may be a transaction that is made by a legitimate credit or debit cardholder whereas an inauthentic digital transaction may be a transaction that is made by someone other than the legitimate credit or debit cardholder (e.g., a bad actor) without the consent of the legitimate cardholder.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. EXAMPLE EMBODIMENTS

The example embodiments described herein are provided for illustrative purposes and are not limiting. The examples described herein may be adapted to any type of business enterprise and/or market. Further structural and operational embodiments, including modifications/alterations, will become apparent to persons skilled in the relevant art(s) from the teachings herein.

Embodiments described herein enable the classification of digital transactions (e.g., authentic or inauthentic) to be carried out accurately in real-time even with incomplete data. Responsive to the determination whether a digital transaction is authentic or inauthentic, the transaction management system may take any number of actions, including but not limited to, modifying network security policies, adjusting transaction management strategies, rejecting a transaction, approving a transaction, generating an alert, halting or terminating a transaction, cancelling a user account, flagging a transaction as inauthentic, or the like. The systems and methods described herein can greatly improve the performance of the transaction management system and the various computing devices, systems and networks underlying such a system. Example improvements include reduction of processing and storage associated with authentic online transactions by rejecting such transaction before they are carried out or by deactivating user accounts that are deemed to be inauthentic. Another example is improving network efficiency of network(s) for which the transaction management system interfaces. Other examples include improved security and accuracy of the transaction management system and its associated computing devices as decision accuracy for digital transactions is enhanced.

Embodiments described herein enable the management of digital transactions with incomplete information with a discriminative data-driven self-adaptive transaction control system. Embodiments are directed to a prospective control framework that can quantify interactive effects of decisions made by different parties and can adjust transaction control strategies using data analytics, artificial intelligence, and dynamic optimization techniques. The different parties include not only merchants but also payment instrument-issuing banks and optionally, manual review agents employed by the merchants. Embodiments described herein solve the problem of short-term optimal decision through a systematic operations research approach called prospective control modelling that account for the actions of the entire decision ecosystem (e.g., merchants, banks, and manual review agents) to better identify inauthentic transactions. Thus, the prospective control framework may systematically perform transaction management by optimizing its transaction classification decisions for maximum long-term gains rather than short-term gains.

The prospective control framework provides technical improvements to the management of digital transactions, particularly the computing devices, systems and networks that are associated with the transaction management system. Example embodiments described herein provide a process for determining control decisions (e.g., approved, reject, or manual review) for digital transactions, and each of the steps in such process may lead to improvement of the security and/or functioning of the computing devices and/or systems and associated networks on which the process is implemented. For example, in determining whether a digital transaction should be rejected as an inauthentic transaction or approved as an authentic transaction, the functioning and/or security of the computing devices, systems and networks may be improved with a significantly enhanced decision accuracy for the digital transaction. In other words, by accurately approving more authentic digital transactions, approving fewer inauthentic digital transactions, sending fewer digital transactions to manual review, network efficiency may be gained and computing resource utilization may improve. For example, with enhanced accuracy, the prospective control framework may send fewer digital transactions to manual review, thereby decreasing the manual review volume. The prospective control framework may also decrease the rejection volume by rejecting much fewer authentic digital transactions but more inauthentic digital transactions. In addition, the prospective control framework may provide better, more accurate approval decisions for authentic digital transactions.

Inauthentic digital transactions present some unique challenges that are unlike other decision-science problems. A first challenge includes bad actors actively attempting to stay below the radar of transaction management systems and changing their attack vectors as soon those systems become good at thwarting them. A second challenge stems from the short-term optimal decisions. First-generation transaction management systems focused on driving loss to low levels (usually dictated by cost of goods (COGS), fees, and penalties imposed by card networks) and largely ignored opportunity loss due to wrongful rejections (i.e., false positives) by the transaction management systems. Second-generation transaction management systems provide better performance by optimizing the choice of the static thresholds applied on the probability assessed by the transaction control models, with an aim to achieve a balance between loss due to inauthentic digital transactions and opportunity loss. However, these transaction management systems assumed the environment was quasi-static and described by long-term average measures. This resulted in decision policies that belied the dynamic nature of the transaction environment and ignored the multiple feedback interaction loops involved between the decision of the control model and the follow-up decisions made by other associated parties, such as financial institutions (e.g., payment card-issuing banks) which have their own transaction management systems.

In example embodiments, at a high level, the transaction management system aims to solve the following equation:

Profit=Margin of legitimate transactions−COGS loss−Review cost

On the plus side is the margin of good transactions that were allowed to happen by the merchant and the banks. On the minus side is the cost of goods sold loss of the inauthentic transaction that happened and operations costs of the transaction management system itself. A high reward or profit may be achieved when the transaction management system can simultaneously drive higher bank acceptance, lower false positives, lower loss due to inauthentic transactions and lower manual review costs.

To drive higher bank acceptance, lower false positives, lower loss due to inauthentic transactions and lower manual review costs, example embodiments described herein provide a systematic operations research approach for digital transactions management. Embodiments are directed to a transaction management system that includes a prospective control model that determines a control decision (approve, reject or manual review) for a digital transaction in real-time. A transaction that is deemed inauthentic may be rejected, whereas a transaction that is deemed authentic may be approved. If there is insufficient information to determine whether a transaction is authentic or inauthentic, human intelligence may be utilized in a manual review process for further investigation of that transaction. The prospective control model differs from conventional transaction management schemes because it accounts for the various decision-making components (e.g., banks and manual review component) that contribute to the final control decision for a digital transaction. Thus, the control decision made by the prospective control model is not isolated from the entire decision environment. Rather the prospective control model includes the behavior patterns of the banks and the manual review component as feedback and may dynamically adjusts its transaction control strategies based on this feedback. Additionally, the prospective control model uses not only attributes for a current transaction (e.g., risk score, cost, and profit margin) but also predicted future bank and/or manual review decision and outcome made for the current transaction. The predicted future decisions may be determined based on fully-matured data of past transactions (which have been confirmed or labeled as authentic or inauthentic) as well as partially-matured data of recent past transactions (some of which have not been definitively labeled as authentic or inauthentic). Partially-matured data may be considered incomplete data as the label for certain transactions may be missing.

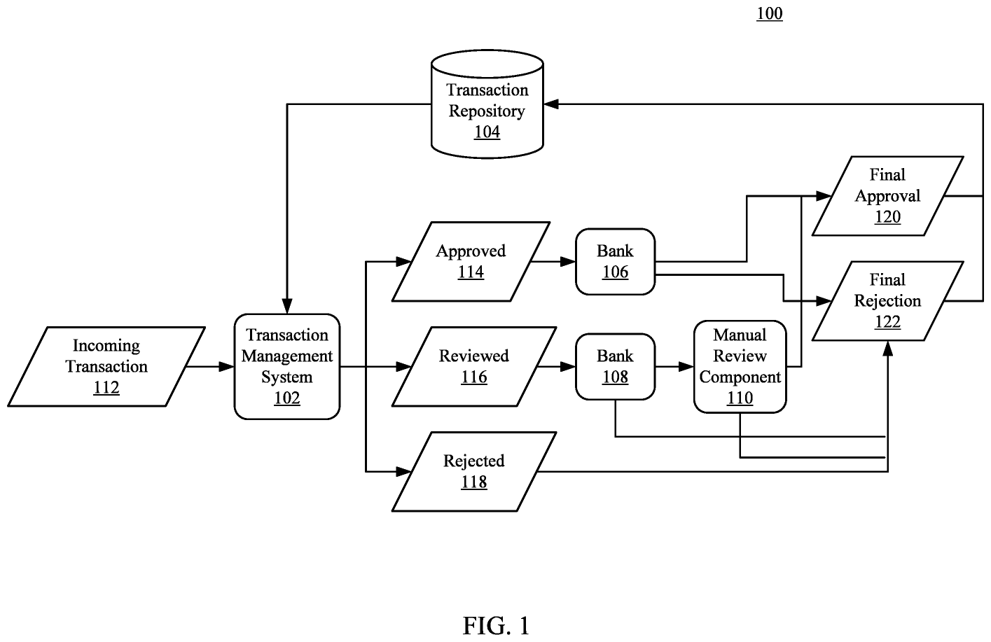

FIG. 1 depicts a decision flow 100 that illustrates how a digital transaction may be processed through different decision-making stations until a final determination is made, according to an embodiment. The decision-making stations include a transaction management system (TMS) 102, a bank 106, a bank 108 and a manual review (MR) component 110. While bank 106 and bank 108 are depicted as separate entities in FIG. 1, they may also be a part of one entity or financial institution.

As shown in FIG. 1, TMS 102 may include a scoring engine. The scoring engine may measure the risk level of each transaction. Instead of assigning a digital transaction with explicit 0-1 (authentic-inauthentic) classification, a merchant may calculate the risk score for each transaction based on its attributes, such as purchase price, order quantity, payment information, product market, etc. For example, a digital transaction may include a user account information (e.g., a user account for an e-commerce platform of a business), product information (e.g., this transaction is requesting a laptop with a particular set of specifications, price and other costs), and payment information (e.g., a credit card bank, Visa/Mastercard channel, payment device, payment IP (internet protocol) address and so on). Occurrence time of the digital transaction may be recorded as “receiving time.” A probability of the digital transaction being inauthentic may be determined and recorded in a database as “RiskScore.” Whenever a transaction with a higher score is seen, it is more likely to be inauthentic. The scoring engine may be implemented using machine learning techniques and models with big data. Thus, the scoring engine may be a machine learning driven, automated engine that processes various properties of incoming digital transactions and then estimates the probability of the transactions as being inauthentic.

TMS 102 may further include a transaction control engine, which may further process the score for a digital transaction provided by the scoring engine. For example, in embodiments, the transaction control engine may consume a score provided by the scoring engine and then apply a suitable control policy to determine whether to accept, reject or refer the digital transaction to MR component 110. Digital transactions that violate predetermined policies or rules may instantly get rejected. The predetermined policies or rules may include those formed based on governmental and merchant-made regulations or those formed based on obvious inauthentic situations and/or data that require immediate blockage. However, many inauthentic transactions may not be detected by these predetermined policies or rules. Accordingly, the transaction control engine may be utilized to prevent these inauthentic transactions based on risk scores provided by the scoring engine.

In an example embodiment, for a digital transaction, the transaction control engine may determine a control decision that may be recorded as “InlineDecision” in a database (e.g., the same database that stores the risk scores). Decisions made by banks 106 and 108 and MR component 110 may be recorded in the same database as “BankDecision” and “MRDecision,” respectively. The digital transaction may include a label that is set to “False” by default in a “InauthenticFlag” field in the database, and after a stochastic data maturity lead time, a final label may be received and the “InauthenticFlag” may be updated to “True” if a chargeback (a reversal of payment) is triggered. The maturity time stamp of the transaction may be recorded as “MaturityTime.” In a streaming data structure of a data set of transactions, the maturity time stamps of multiple transactions may be simultaneously recorded.

Conventional control measures may apply static thresholds, for example: approve transactions with scores lower than a low score threshold; reject transactions with scores higher than a high score threshold; and utilize human intelligence (manual review) for further investigations on transactions with scores in-between. The thresholds may be set such that the transaction management system can optimally prevent attacks from bad actors. This threshold band method remains popular, despite the fact that score evaluation has been significantly improved during the past few years. The three main reasons why transaction classification made based on scores are not always reliable include: rapid changes in behavior patterns of bad actors; loss of signals from rejected transactions, and long data maturity lead time. Because of these issues, the threshold band method lacks flexibility and capability of real-time self-adjustment, and therefore cannot always provide the most accurate control decisions.

In embodiments, TMS 102 employs a transaction control engine that does not suffer from the drawbacks of the threshold band method because it accounts for the various decision-making components (e.g., banks and manual review component) that contribute to the final determination in different transaction flows. The control decision made by a merchant is therefore not isolated from the entire decision environment, where payment issuing banks and manual review component make follow-up decisions that constitute the final control decision on every transaction. In example embodiments, TMS 102, specifically, the transaction control engine, follows an operations research approach. Thus, rather than having decision thresholds as semi-static parameters, the transaction control engine may treat them as knobs of a multistage decision system with feedback that it could control dynamically. This prospective control framework quantifies the interactions between the decisions made by different parties (e.g., bank 106, bank 108 and MR component 110) in decision flow 100 and allows transaction control strategy adjustments based on the availability of data attributes and labels (e.g., authentic or inauthentic) of transactions. The transaction control engine uses not only attributes for a current transaction (e.g., score, cost, and profit margin) but predicted future bank and/or manual review decision and outcome made for the current transaction as well in classifying the current transaction as authentic or inauthentic. Thus, the transaction control engine may employ fully-matured data of past transactions (also described herein as historical matured data), partially-matured data of recent transactions (also described herein as incomplete data), and predicted future outcomes. In an example embodiment, the transaction control engine may utilize one or more machine learning models in the prospective control framework.

In an example embodiment, incoming transaction 112 arrives at TMS 102. TMS 102 is configured to determine a score (e.g., via the scoring engine) based on all features associated with transaction 112. The score represents the likelihood of transaction 112 being inauthentic. TMS 102 is further configured to determine a final decision based on some attributes of transaction 112, including the score provided by the scoring engine. If transaction 112 is approved 114 by TMS 102, then transaction 112 proceeds to bank 106 for a follow-up decision. If transaction 112 is approved by bank 106, it is marked as a final approval 120. If transaction 112 is declined by bank 106, it is marked as a final rejection 122. If transaction 112 is rejected 118 by TMS 102, it may be directly marked as final rejection 122. If transaction 112 is neither approved nor rejected by TMS 102, it may be sent to bank 108 first. If bank 108 authorizes transaction 112, it would then be sent to MR component 110 for further investigation for its final determination or classification. In this manner, manual review resources would not be spent on a transaction that bank 108 would not approve. MR component 110 may access extra information such as a purchase history for a customer, or electronic mail (email), telephone and address reputation associated with the customer to further investigate transaction 112 to determine whether it should be classified as authentic or inauthentic. If bank 108 rejects transaction 112, then it would be marked as final rejection 122. The final classification or determination for transaction 112, final approval 120 and final rejection 122, may be saved in transaction repository 104 for future reference.

In FIG. 1, bank 106 and bank 108 are illustrated as singular entities for simplicity. However, these entities may comprise multiple institutions and/or computing systems that may operate on an individual basis or a networked basis. As more and more transactions are processed through TMS 102, important data may be gleaned, stored and used for classification of future incoming transactions. Furthermore, the decisions made by transaction management system 102 utilized by a merchant, bank 106, bank 108 and MR component 110 for each transaction are not independent.

For example, if TMS 102 approves and submits transactions that include more inauthentic transactions (e.g., false negative or wrongful approval) to bank 106 and bank 108, bank 106 and bank 108 may become more conservative and may decree more rejections of good transactions (e.g., false positive or wrongful rejection). Thus, the inauthentic transactions which bypass TMS 102 have a strong negative impact on the bank's authorization decision after a short period of time (e.g., one month). For example, a one-percentage-point increase in inauthentic transaction rate may cause a fifteen-percentage-point decrease in the bank's acceptance rate. Thus, to influence the bank to accept more transactions, the merchant needs to block more inauthentic transactions.

Furthermore, if TMS 102 submits transactions that include fewer inauthentic transactions (e.g., false negative or wrongful approval) to MR component 110, MR component 110 may have a much harder time making an accurate final determination regarding a transaction because inauthentic transaction patterns are less massive and recognizable. Digital transactions may be classified or labeled as authentic transactions if they are rejected by MR component 110 for different reasons or if the merchant has received chargeback requests from bank 106 or bank 108. Such label may be used for further improvement of the scoring engine and/or the transaction control engine. Thus, determinations of MR component 110 and chargeback requests from bank 106 and bank 108 may be used by TMS 102 in classification of transactions through the updated prospective control model. For example, TMS 102 may dynamically adjust its transaction control strategies based on the determinations of MR component 110 and chargeback requests from bank 106 and bank 108. If the merchant, by way of TMS 102, rejects almost all authentic transactions, then this may result in little or no confirmed authentic labels. This may cause fewer labels to be available for model training, rendering future control determinations made by TMS 102 inaccurate. This cycle may continue and progressively get worse if it is not carefully attenuated.

While a credit or debit cardholder is protected from the financial liability of unauthorized card transactions, there is a significant difference in how losses due to inauthentic transactions are handled between merchants and the card-issuing banks depending on whether the inauthentic transactions occurred online or in a brick-and-mortar store.

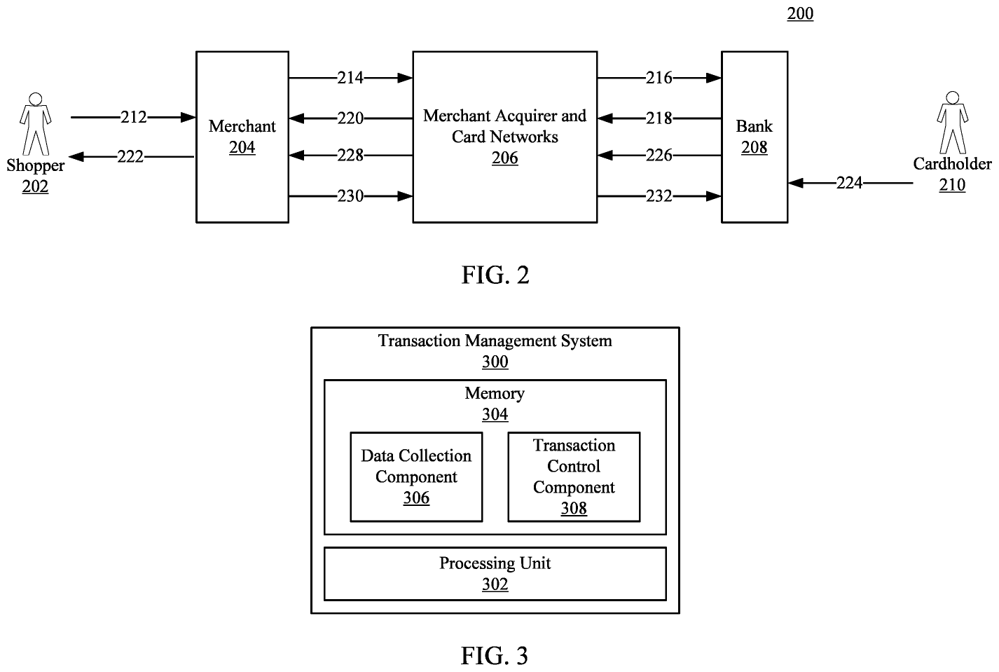

FIG. 2 depicts a life cycle 200 of a payment of an online purchase, according to an embodiment. For example, a shopper 202 may make a purchase from a merchant 204 (e.g., via an e-commerce platform of merchant 204) and shopper 202 may present a form of payment (e.g., a credit or debit card) as payment request 212. Payment request 212 is transmitted by merchant 204 as authorization request 214 to intermediaries, such as merchant acquirer and card networks 206 (networks 206), which forwards authorization request 214 as authorization request 216 to bank 208. Bank 208 may be a bank that issued the card used by shopper 202. Bank 208 may choose to authorize or reject authorization request 216. If bank 208 authorizes authorization request 216, funds 218 may be distributed from bank 208 to networks 206, which may forward funds 218 as funds 220 to merchant 204. Thereafter, merchant 204 may deliver goods and/or services 222 purchased by shopper 202.

If shopper 202 is a bad actor and had used information from a stolen card for the online purchase, the true or legitimate holder 210 of the card may dispute 224 the purchase with bank 208. This dispute may result in a chargeback, which is a reversal of payment that comes from bank 208. The chargeback is different from a traditional refund in that the traditional refund comes from a merchant, whereas the chargeback is by a bank based on a request from a cardholder. If bank 208 deems the request from cardholder 210 valid, funds may be removed from the account of merchant 204 and returned to cardholder 210.

In the case of brick-and-mortar commerce, the bank takes liability for inauthentic purchases, ones made by a bad actor who is not a legitimate cardholder. That is, the bank may withdraw the inauthentic charge from the account of the cardholder and accepts the inauthentic charge as a loss—a cost of doing business. As shown in FIG. 2, in e-commerce, bank 208 may initiate a chargeback request 226 via networks 206, which forwards the chargeback request 226 to merchant 204 as chargeback request 228. Network 206 may comprise one or more networks such as local area networks, wide area networks, enterprise network, the Internet, etc., and may include one or more wired and/or wireless portions. Merchant 204 is required, by law, to return the funds 230 associated with the online transactions via networks 206, which forwards funds 230 as funds 232 to bank 208, if merchant 204 cannot prove it was an authentic transaction. In this case, merchant 204 must bear the loss of the cost of goods obtained by the bad actor. To make matters worse for merchant 204, a fee for the chargeback may be assessed, causing losses even greater than the digital transaction.

For a purchase at a brick-and-mortar store, the card-issuing bank has a strong physical authentication that the card being proffered for payment is not counterfeit. In contrast, an e-commerce transaction has a “Card-Not-Present” (CNP) format, in which the purchaser simply provides a card number and some ancillary information, thus the issuing bank cannot physically verify the presence of the legitimate cardholder. Therefore, digital transactions over a network are highly susceptible to abuse and misuse, and the liability of such transactions is pushed onto the merchant.

Numerous ways exist to implement transaction management system 102. For example, FIG. 3 is a block diagram of a transaction management system (TMS) 300, according to an embodiment. TMS 300 includes a processing unit 302, a memory 304, a data collection component 306, and a transaction control component 308. While not shown in FIG. 3, TMS 300 may include network interfaces or other means for establishing communications over one or more networks (e.g., the Internet, local area networks, wide area networks, or enterprise network).

Processing unit 302 is an electrical and/or optical circuit implemented in one or more physical hardware electrical circuit device elements and/or integrated circuit devices (semiconductor material chips or dies) as a central processing unit, a microcontroller, a microprocessor, and/or other physical hardware processor circuit. Processing unit 302 may include one or more processors and may execute program code stored in memory 304 or a computer readable medium, such as program code of an operating system, application programs, or other programs, etc.

Memory 304 includes read only memory (ROM) and random access memory (RAM) and is used to store program modules, for example, computer program logic (e.g., computer program code or instructions) for implementing a data collection component 306 and a transaction control component 308. Data collection component 306 is configured to collect data regarding digital transactions, for example, features that may be quantitative functions (e.g., numbers, categories, and Boolean variables) built based on semantic knowledge about the digital transactions. A feature can thus be any measurable characteristic of a transaction, ranging from something simple such as product type, purchase amount, currency, device type, browser language, etc., to something more comprehensive (aggregated) such as “how many transactions the account associated with the current transaction has made during the past day” or a count indicating whether a transaction is connected , via multiple hops, to islands or locations and/or systems known for having inauthentic-transaction-related activities. In addition, data collection component 306 may be configured to collect other data not specifically related to a particular transaction, such as user forensics (e.g., account information, purchase history), location (e.g., user device geolocation, billing and/or shipping address), device forensics (e.g., operating system configuration, hardware configuration, browser or device configuration), etc.

In embodiments, transaction control component 308 may be implemented as a scoring engine and/or transaction control engine, such as the ones described above in reference to TMS 102 of FIG. 1. For example, the scoring engine may utilize one or more machine learning models to produce the risk scores and the transaction control engine may use the risk scores and rules and/or policies to make risk decisions regarding transactions.

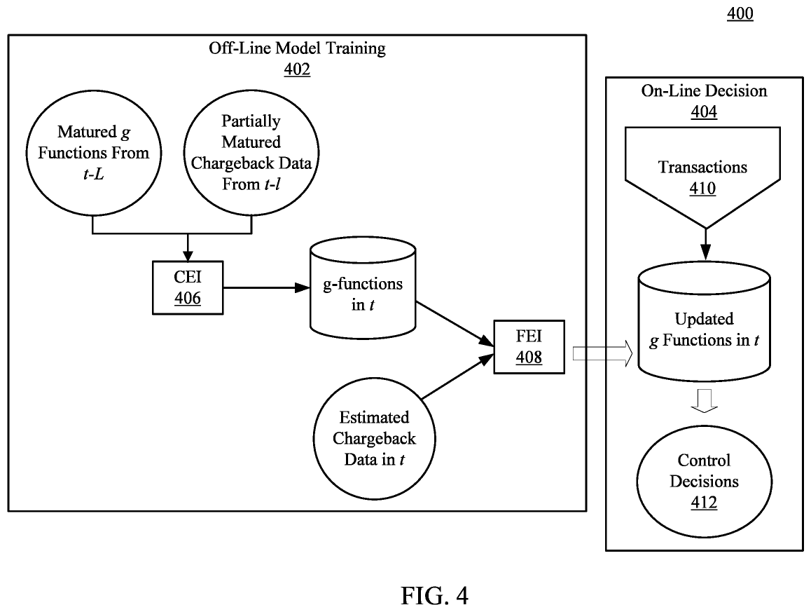

Transaction control component 308 may employ various transaction control methods. For example, FIG. 4 depicts a flow of a transaction control algorithm 400 that may be implemented by transaction control component 308, according to an embodiment. Transaction control algorithm 400 quantifies interdependent effects of decisions made by different parties. Transaction control algorithm 400 further adjusts transaction control strategies based on the availability of data attributes and labels, applying data analytics and dynamic optimization techniques using a prospective control model to make automated decisions or determinations (approval, rejection, or manual review) for each digital transaction. Accordingly, a current decision for a transaction made at a current period t, is based not only on the features of the transaction (i.e., score, cost, and margin) but also the expected return of the transactions in a future period, t+l, based on the current decision.

In an embodiment, transaction control algorithm 400 includes a prospective control model with an off-line model training process 402 and an on-line decision process 404.

Decision responses (i.e., transaction labels) may be inaccessible immediately after control actions (approve, review or reject) are taken. In transaction control, labels for purchase transactions may be delayed, due to the fact that it requires stochastic amount of time for bank account holders to realize that their accounts have been misappropriated and send dispute requests to their banks. In this case, business intelligence models may not have access to up-to-date data set to capture the most recent decision environment patterns and recognize the concept drift of the target system's performance measures. This delay lead time may be referred to as data maturity lead time in big data era. If recent data is ignored and only matured data is used to estimate behavior patterns of decision parties, then the transaction control policy may be outdated due to the lag of pattern recognition. If data maturity lead time is ignored and partial labels are used to estimate behavior patterns of decision parties, it may be possible to overestimate recent decision quality, and in turn overestimate approval rates of banks or manual review agents. To dynamically estimate the rapidly fluctuating decision environment for e-commerce transaction control, two frameworks may be used, a current environment inference framework 406 (CEI 406) and a future environment inference framework 408 (FEI 408), that tackle maturity lead time issues in decision environment knowledge acquisition. Both frameworks first generate decision environment related features using long-term matured data and short-term partially matured data, and estimate decision environment using various regression based methods, including linear regression, random forest, gradient boosted decision tree, and recurrent neural network. CEI 406 may be designed to use partially matured data to estimate decision environment of current decision epoch. FEI 408 may be designed to further estimate decision environment of a future decision epoch to help evaluate effect of current control decisions in the future decision epoch. Although these frameworks may be designed for transaction control, they may be easily customized for other industry applications that face challenges of stochastic data maturity lead time.

In an embodiment, let L be the maximum data maturity time, then at the beginning of period t, available streaming data may be separated into two segments:
a. Long-term matured data: streaming data with time stamps of no later than t−L;
b. Short-term partially matured data: streaming data with time stamp from L+1 to t−l.
   A batch of transactions occur during period t′, then the time stamps for these transactions may be recorded in the database as “period” with value t′.

Decision environment of inline transaction control is characterized by probabilistic measures of the bank and manual review behavior patterns. Decision environment characteristics may be in the form of conditional probabilities. Let s denotes a risk score of a transaction, where s has finite integral support S={s₁, s₂, . . . , s_{|S|}}, decision environment of optimal transaction control may be characterized by the following five probabilistic functions:
a. Probability that a transaction with score s will be authorized by the bank and turns out to be authentic:

$$\begin{matrix}{g}_{1} ( s ) = Pr ( Bank Auth . ⋂ Authentic \vert s ) \\ = \frac{\# of bank auth . and authentic transactions}{\# of finally approved transactions}\end{matrix}$$

b. Probability that a transaction with score s will be authorized by the bank and turns out to be inauthentic:

$$\begin{matrix}{g}_{2} ( s ) = Pr ( Bank Auth . ⋂ Inauthentic \vert s ) \\ = \frac{\# of bank auth . and inauthentic transactions}{\# of finally approved transactions}\end{matrix}$$

c. Probability that a transaction with score s will be authorized by the bank and approved by manual review, and finally turns out to be authentic:

$${g}_{3} ( s ) = Pr ( Bank Auth . ⋂ MR approved ⋂ Authentic \vert s ) = \frac{\# of bank auth . , MR approved and authentic transactions}{\# of finally approved transactions}$$

d. Probability that a transaction with score s will be authorized by the bank and approved by manual review, and finally turns out to be inauthentic:

$${g}_{4} ( s ) = Pr ( Bank Auth . ⋂ MR approved ⋂ Inauthentic \vert s ) = \frac{\# of bank auth . , MR approved and inauthentic transactions}{\# of finally approved transactions}$$

e. Probability that a transaction with score s will be authorized by the bank and sent to manual review for further investigation:

$$\begin{matrix}{g}_{5} ( s ) = Pr ( Bank Auth . \vert s ) \\ = \frac{\# of bank auth . transactions}{\# of finally approved transactions}\end{matrix}$$

These five probabilistic g functions are short for “gold functions,” since their values describe reward or profit related probabilities associated with different risk operations in a transaction control system. g₅(⋅) may be estimated using the most recent transaction streaming data, as the bank decision signals are available instantly (e.g., within a few seconds). On the other hand, estimating g₁(⋅), g₂(⋅), g₃(⋅) and g₄(⋅) are not trivial tasks because up-to-date labels are not available due to data maturity lead time.

CEI 406 may include two segments, a data preprocessing module and a learning module. As the size of transaction streaming data set expands by each period, CEI 406 may be updated at the beginning of each decision period. Most updated transaction streaming data set may be first preprocessed into a training data set, and machine learning and/or deep learning method(s) may be deployed to build a model for the current decision environment inference.

For the data preprocessing module, the decision environment of period t (e.g., one week) is characterized by g₁^{t}(s) for all s∈S. Then, at any given risk score s, g₁^{t}(s) is a time series along the time axis. g₁^{t}(s₁) may be correlated with g₂^{t}(s₂) for s₁≠s₂ for any period t, and risk score s and time stamp t may be included as two features of draining data. Data maturity lead time may be at most L (e.g., three months), thus at the beginning of period t, it is possible to access the exact decision environment for periods earlier than t−L. In this way, it is possible to include the most recent matured M decision environment information, i.e., g₁^{t-L-D+1}(⋅), g₂^{t-L-D+2}(⋅), . . . , g₁^{t-L}(⋅), as features of the training data. Given the fact that the bank and the MR team may adjust their behavior patterns, it is possible to calculate biased chargeback rates in recent periods using partially matured streaming data. For example, it may not be possible to access chargeback rates ρ^{t}′ in period t′, but biased charge back rate \tilde{ρ}^{t}′ may be calculated for t′∈(t−L+1, . . . , t−1}. Using correlation tests, it may be possible to determine if any of the biased chargeback rates have connections with, g₁^{t}( . . . ). The most related \tilde{ρ}^{t}′ may be included as features of the training data, e.g., if \tilde{ρ}^{t-l} has significant correlation with g₁^{t}, this biased chargeback rate may be included for period t−l into the feature set of training data. Responses of the training data are the exact g₁^{t}(s) values.

The construction of the above training data is adopted from trajectory prediction research. For each risk score s, g₁^{t}(s) at a series of time t may be considered as a trajectory. Furthermore, for different s, the trajectory of g₁ might be correlated and should not be estimated separately. The inclusion of the most recent matured M decision environment information, i.e., g₁^{t-L-D+1}(⋅), g₂^{t-L-D+2}(⋅), . . . , g₁^{t-L}(⋅), as features of the training data is to record the most recent available exact trajectory to estimate the long-term level and trend of the g₁ function. On the other hand, inclusion of a recent biased chargeback rate \tilde{ρ}^{t-l} in the feature set of the training data provides a short-term calibration factor to amend the long-term g₁ function estimation so that the g₁ function estimation is more reflective of the most recent decision environment.

The learning module of CEI 406 may be considered as a regression problem that maps input features to an estimation of a current period g₁ function. A number of alternative methods may be considered as the core learning model in machine learning and deep learning, such as linear regression, random forest, gradient boosted tree, and recurrent neural network With the model trained (and model parameters are tuned using cross validation), the beginning of period t, the most recent D matured g₁ function, i.e., g₁^{t′}(s) for t−L−D+1≤t−L at all s∈S, and calibration factor, i.e., \tilde{ρ}^{t-l}, compose the input, and CEI 406 outputs estimation of g₁ function for period t for all s∈S, denoted as g₁^{t′}(s).

The estimation of g₁(⋅) is described above for illustration, and because the estimation of g₂(⋅), g₃(⋅) and g₄(⋅) follows the exact same procedures, their estimation will not be described in detail herein.

Returning to FIG. 4, FEI 408 may include a data preprocessing module and two learning modules. Like CEI 406, FEI 408 may be updated once per period, after including new streaming data and updating transaction labels. However, FEI 408 differs from CEI 406 in the following ways:
a. The data processing module of FEI 408 transforms transaction streaming data into two training data sets: (1) training data set I includes g₁ function trajectories of length D, and contributes in training learning module I; and (2) training data set II includes shorter g₁ function trajectories of length D−l, which may be used by learning module II.
b. Two training data sets may be fed into two learning modules, learning module I is identical to CEI 406's learning module, and learning module II is a modified version of CEI 406's learning module with a shorter g₁ function trajectory for training and prediction.

The features that may be used to estimate the future decision environment and the preprocessing of streaming data into training data sets for FEI 408 are described next.

CEI 406 suggests that D most recent matured g₁ function trajectory may be preprocessed into a training feature set, e.g., for period t+l long-term trend of g₁ function should be estimated from g₁^{t+l-L-D+1}(⋅) to g₁^{t+l-L}(⋅). However, at the beginning of period t, only g₁^{t+l-L-D+1}(⋅) may accessible to g₁^{t-L}(⋅). Thus, g₁^{t+l-L-D+1}(⋅) to g₁^{t-L}(⋅) may be used to estimate long-term trend of g₁^{t+l}(⋅), so that this shorter trajectory of length D−l may be included in the feature set. CEI 406 also suggests that chargeback rate in period t, i.e., ρ^{t}, is correlated with g₁^{t+l}(⋅), which may be included into the feature set that contributes to preprocess training data II.

Training data set II may not be enough to estimate the decision environment in period t+l because when g₁^{t+l} is predicted at any time in period t, the chargeback rate, ρ^{t}, may be unknown. However, access to g₂^{t}(s) and g₄^{t}(s) may be possible, for an inline action sequence from the beginning of period t to the time g₁^{t+l} estimations are made, {aᵢ^{t}: i=1, 2, . . . , m, aᵢ^{t}∈{App, Rev, Rej}}, and transaction risk score sequence {sᵢ^{t}: i=1, 2, . . . , m}, an estimation of pt may be obtained,

$${\hat{ρ}}^{t} = \frac{1}{{\sum }_{i = 1}^{m} {δ}_{( {a}_{i}^{t} \neq Rej )}} ( {\sum }_{i = 1}^{m} {g}_{2}^{t} ( {s}_{i}^{j} ) \cdot {δ}_{( {a}_{i}^{t} = A p p )} + {\sum }_{i = 1}^{m} {g}_{4}^{t} ( {s}_{i}^{t} ) \cdot {δ}_{( {a}_{i}^{t} = R eν )} )$$

where δ_{(H)} is an indicator function of event H, i.e., δ_{(H)}=1 if H is true and δ_{(H)}=0 otherwise. Thus, CEI 406 may be used to first obtain estimations of g₂^{t}(s) and g₄^{t}(s), which may be used to determine \hat{ρ}^{t}. The construction of training data set I of FEI 408 may the same as the construction of the training data set for CEI 406.

FEI 408 may include two learning modules. Learning module I produces a model that maps the most recent D matured g function trajectory, i.e., g^{t′}(s) for t−L−D+1≤t′≤t−L at all s∈S, and calibration factor, i.e., \hat{ρ}^{t}, to g function estimations, ĝ₁^{t}(⋅) for j∈{1, 2, 4}. With ĝ₂^{t}(⋅) and ĝ₄^{t}(⋅), the current period chargeback rate may be estimated, i.e., ρ^{t}, at any time point during period t. Learning module II may then be used to produce a model that maps a shorter recent matured g function trajectory, i.e., g^{t′}(s) for t−L−D+l+1≤t′≤t−L at all s∈S, and calibration factor, i.e., \hat{ρ}^{t}, to g₁ function estimation in period t+l, ĝ₁^{t+l}(⋅). Similar to CEI 406, FEI 408 may use a variety of learning cores for learning modules I and II, such as linear regression, random forest, gradient boosted tree, and recurrent neural network.

Once the prospective control model of transaction control algorithm 400 is trained off-line, the output of off-line model training process 402 (i.e., updated g functions in period t) may be used for on-line decision process 404. During on-line decision process 404, the prospective control model may generate control decisions 412 by determining whether incoming transactions 410 should be approved, rejected, or manually reviewed.

As shown in FIG. 4, transaction control algorithm 400 may be purely data-driven and self-adaptive in a real-time manner. Transaction control algorithm 400 may also be customized for a particular business, thereby accounting for the unique nature of the particular business. For example, a transaction for a digital product may require no manual review. Therefore, when transaction control algorithm 400 is applied to a business that involves digital products, elements (e.g., manual review cost) and/or components (e.g., MR component 110 of FIG. 1) regarding manual review may be removed.

Transaction control algorithm 400 may provide specific technical improvements to the systems (e.g., TMS 300), computing device(s) and networks on which it is being executed. For example, during on-line decision process 404, control decisions 412 may be generated for incoming transactions 410. Due to the implementation of FEI 408 that helps evaluate the effect of current control decisions in the future, more accurate control decisions may be made in the long term for current incoming transactions. Thus, fewer transactions may be sent to manual review, fewer authentic transactions may be rejected, resulting in network efficiency gains. Moreover, fewer computing resources (e.g., processing power, memory, etc.) may be needed.

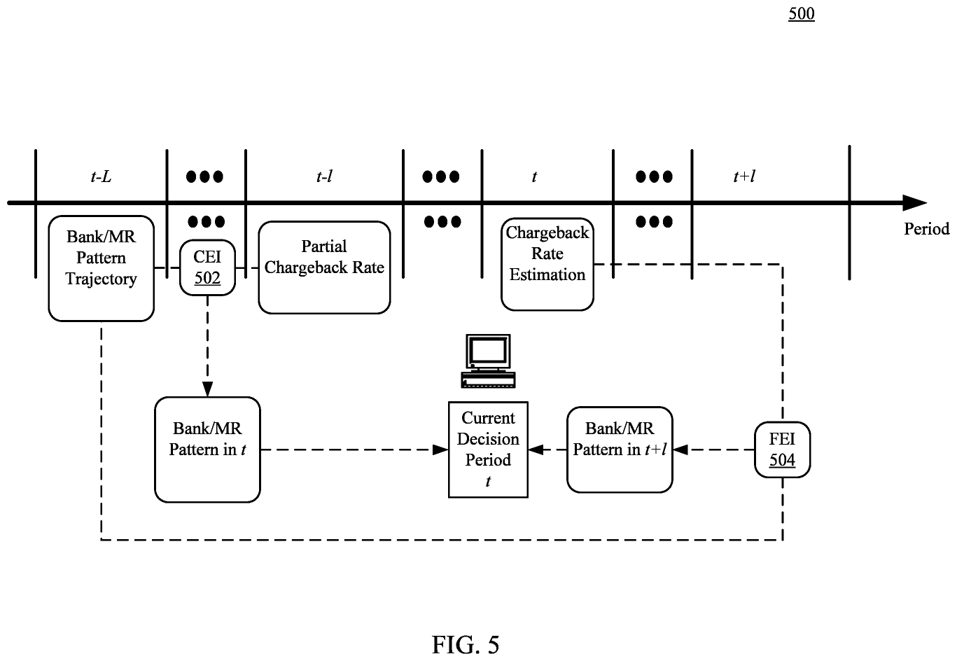

FIG. 5 depicts a decision flow of a prospective control algorithm 500, according to an embodiment. Although described with reference to system 300 of FIG. 3, prospective control algorithm 500 is not limited to that implementation. Other structural and operation embodiments will be apparent to persons skilled in the relevant art(s) based on the following discussion regarding system 300 of FIG. 3.

As shown in FIG. 5, fully matured data includes transactions that occurred before time period t−L, partially matured data includes transactions that occurred between t−L and t−l, and predicted outcomes are made for time period t to t+l. The prospective control algorithm may resolve the pattern recognition lag issue due to the delay of label maturity. t is the current decision period.

For example, for a transaction, w, to estimate the expected reward of the decision being “approval” or “review,” the following equations may be used, equation 1 and equation 2, respectively:

$$\begin{matrix}\begin{matrix}E [ {R}_{App} ( w ) \vert s ] = Pr ( Bank Auth . ⋂ NonFraud \vert s ) \times m - \\ Pr ( Bank Auth . ⋂ Fraud \vert s ) \times c \\ = {g}_{1} ( s ) \cdot m - {g}_{2} ( s ) \cdot c\end{matrix} & ( 1 ) \\ \begin{matrix}E [ {R}_{Rev} ( w ) \vert s ] = Pr ( Bank Auth . ⋂ MR App ⋂ NonFraud \vert s ) \times m - \\ Pr ( Bank Auth . ⋂ MR App ⋂ Fraud \vert s ) \times c - \\ Pr ( Bank Auth . \vert s ) \times {c}_{0} \\ = {g}_{3} ( s ) \cdot m - {g}_{4} ( s ) \cdot c - {g}_{5} ( s ) \cdot {c}_{0}\end{matrix} & ( 2 )\end{matrix}$$

where m is the margin earned, c is the cost of goods, c₀ is the unit cost for each manual review, and s is the risk score for this specific transaction, w.

Current environment inference framework 504 (CEI 504) may operate in the same manner as CEI 406 shown in FIG. 4. CEI 504 is used to represent the interaction effect of decisions made by the transaction management system (e.g., TMS 300 of FIG. 3), banks, and manual review agents at the current decision period, t. CEI 504 maps g function trajectories g₁^{t}′(s), g₂^{t}′(s), g₃^{t}′(s), g₄^{t}′(s) and g₅^{t}′(s), (t′<t−L), and partially matured chargeback ρ_{PCB}^{t-l} to estimate the g functions ĝ₁^{t}(s), ĝ₂^{t}(s), ĝ₃^{t}(s), ĝ₄^{t}(s) and ĝ₅^{t}(s) at the current decision period, t.

$$[ \begin{matrix}{\hat{g}}_{1}^{t} ( s ) \\ {\hat{g}}_{2}^{t} ( s ) \\ {\hat{g}}_{3}^{t} ( s ) \\ {\hat{g}}_{4}^{t} ( s ) \\ {\hat{g}}_{5}^{t} ( s )\end{matrix} ] = [ \begin{matrix}{\hat{Ψ}}_{1}^{t} ( s , {g}_{1}^{t ′} ( s ) , {ρ}_{PCB}^{t - l} ( τ ) ) \\ {\hat{Ψ}}_{2}^{t} ( s , {g}_{2}^{t ′} ( s ) , {ρ}_{PCB}^{t - l} ( τ ) ) \\ {\hat{Ψ}}_{3}^{t} ( s , {g}_{3}^{t ′} ( s ) , {ρ}_{PCB}^{t - l} ( τ ) ) \\ {\hat{Ψ}}_{4}^{t} ( s , {g}_{4}^{t ′} ( s ) , {ρ}_{PCB}^{t - l} ( τ ) ) \\ {\hat{Ψ}}_{5}^{t} ( s , {g}_{5}^{t ′} ( s ) , {ρ}_{PCB}^{t - l} ( τ ) )\end{matrix} ] \qquad ( CEI )$$

A real-time greedy heuristic (RGH) may be utilized to obtain an optimal solution of approve, reject or manual review for a transaction. This optimal solution may then be used to update a chargeback rate of period t, \hat{ρ}_{CB}^{t}, which may then be utilized to update the estimation of the g functions, these two functions form the future environment inference framework 504 (FEI 504) shown in FIG. 5.

Similar to transaction control algorithm 400, prospective control algorithm 500 provides the same or similar technical improvements to the systems (e.g., TMS 300), computing device(s), and networks on which it is being executed.

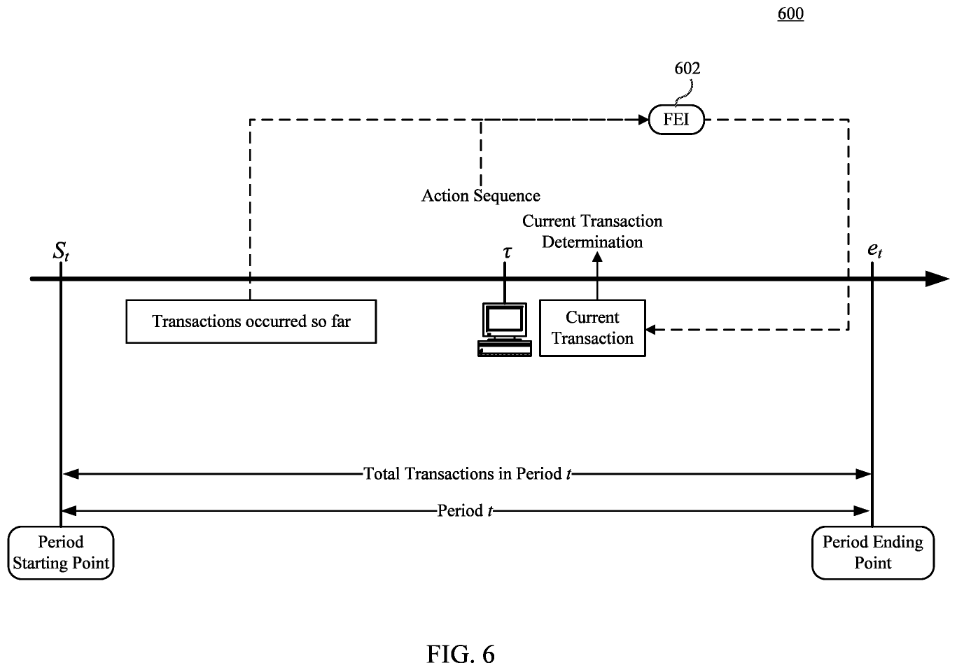

FIG. 6 depicts the logic of a real-time greedy heuristic (RGH) 600, according to an embodiment. RGH 600 enables the transaction management system (e.g., TMS 300 shown in FIG. 3) to update the estimation of the chargeback rate, \hat{ρ}_{CB}^{t}, on the fly and to adjust the transaction control strategy employed by TMS 300 within period t. The updated chargeback rate may then be used to update the g functions and to further calculate the expected reward of each possible decision (approve, reject, or manual review) dynamically for each digital transaction.

FIG. 6 illustrates the logic of RGH 600 within period t. Let time τ, be a decision time point in period t where transaction ωₙ_{₁}₊₁^{t} occurs and TMS 300 needs to make a decision to approve, reject, or manually review this transaction. Suppose from sₜ starting point of period t, to current decision point τ, n₁ transactions have been observed. The chargeback rate of period t may be estimated, if ωₙ_{₁}₊₁^{t} are approved or reviewed using equation 3 below:

$${\hat{ρ}}_{CB}^{t} ( {τ}_{j} ) = \frac{1}{{\sum }_{j = 1}^{{n}_{1} + 1} {δ}_{( {a}_{j}^{t} \neq Rej . )}} ( {\sum }_{j = 1}^{{n}_{1} + 1} {\hat{g}}_{2}^{t} ( {s}_{t}^{j} ) \cdot {δ}_{( {a}_{j}^{t} = App . )} + {\sum }_{j = 1}^{{n}_{1} + 1} {\hat{g}}_{4}^{t} ( {s}_{t}^{j} ) \cdot {δ}_{( {a}_{j}^{t} = Rev . )} ) , \qquad ( 3 )$$

where δ_{(⋅)} is an indicator function.

With this estimated chargeback rate, all five future g functions, ĝ₁^{t}(s), ĝ₂^{t}(s), ĝ₃^{t}(s), ĝ₄^{t}(s), and ĝ₅^{t}(s), could be estimated with matured g-function trajectories g₁^{t}′(s), g₂^{t}′(s), g₃^{t}′(s), g₄^{t}′(s) and g₅^{t}′(s) as

$$[ \begin{matrix}{\hat{g}}_{1}^{t} ( s ) \\ {\hat{g}}_{2}^{t} ( s ) \\ {\hat{g}}_{3}^{t} ( s ) \\ {\hat{g}}_{4}^{t} ( s ) \\ {\hat{g}}_{5}^{t} ( s )\end{matrix} ] = [ \begin{matrix}{\hat{Ψ}}_{1}^{t} ( s , {g}_{1}^{t ′} ( s ) , {\hat{ρ}}_{CB}^{t} ( τ ) ) \\ {\hat{Ψ}}_{2}^{t} ( s , {g}_{2}^{t ′} ( s ) , {\hat{ρ}}_{CB}^{t} ( τ ) ) \\ {\hat{Ψ}}_{3}^{t} ( s , {g}_{3}^{t ′} ( s ) , {\hat{ρ}}_{CB}^{t} ( τ ) ) \\ {\hat{Ψ}}_{4}^{t} ( s , {g}_{4}^{t ′} ( s ) , {\hat{ρ}}_{CB}^{t} ( τ ) ) \\ {\hat{Ψ}}_{5}^{t} ( s , {g}_{5}^{t ′} ( s ) , {\hat{ρ}}_{CB}^{t} ( τ ) )\end{matrix} ] \qquad ( FEI )$$

where t′<t−L. This is the future environment inference framework 602 (FEI 602) shown in FIG. 6. FEI 602 may be implemented as FEI 504 shown in FIG. 5 or FEI 408 shown in FIG. 4.

Using RGH 600, prospective control algorithm 500 may determine the optimal risk decision for transaction wⱼ^{t} with features of score, margin, and cost of goods (sⱼ^{t}, mⱼ^{t} and cⱼ^{t}) at time t, that maximizes total expected reward with the following equations:

$${max}_{{a}^{t} ∈ {A}^{t}} E [ {\sum }_{j = 1}^{N ( t )} {\hat{R}}_{{a}_{j}^{t}} ( {w}_{j}^{t} ) ] + λ \cdot Δ$$

$$s . t . \\ E [ {\hat{R}}_{App} ( {w}_{j}^{t} ) ] = {\hat{g}}_{1}^{t} ( {s}_{j}^{t} ) \cdot {m}_{j}^{t} - {\hat{g}}_{2}^{t} ( {s}_{j}^{t} ) \cdot {c}_{j}^{t} , ∀ j$$

$$E [ {\hat{R}}_{R e ν} ( {w}_{j}^{t} ) ] = {\hat{g}}_{3}^{t} ( {s}_{j}^{t} ) \cdot {m}_{j}^{t} - {\hat{g}}_{4}^{t} ( {s}_{j}^{t} ) \cdot {c}_{j}^{t} - {\hat{g}}_{5}^{t} ( {s}_{j}^{t} ) \cdot {c}_{0} , ∀ j$$

$$E [ {\hat{R}}_{R e j} ( {w}_{j}^{t} ) ] = 0 , ∀ j$$

$${A}^{t} = {\{ App , Rev , Rej \}}^{N ( t )}$$

where λ is a discount factor and Δ is a referential future profit of t+l.

$$Δ \approx {Δ}_{{τ}_{j} , a} = {max}_{{a}^{t + l} ∈ {A}^{t + l}} E [ {\sum }_{j = 1}^{N ( t )} {\hat{R}}_{{a}_{j}^{t}} ( {w}_{j}^{t + l} ) ] \\ s . t . \\ E [ {\hat{R}}_{App} ( {w}_{j}^{t + l} ) ] = {\hat{g}}_{1}^{t + l} ( {s}_{j}^{t + l} ) \cdot {m}_{j}^{t + l} - {\hat{g}}_{2}^{t + l} ( {s}_{j}^{t + l} ) \cdot {c}_{j}^{t + l} , ∀ j \\ E [ {\hat{R}}_{R e v} ( {w}_{j}^{t + l} ) ] = {\hat{g}}_{3}^{t + l} ( {s}_{j}^{t + l} ) \cdot {m}_{j}^{t + l} - {\hat{g}}_{4}^{t + l} ( {s}_{j}^{t + l} ) \cdot {c}_{j}^{t + l} - {\hat{g}}_{5}^{t + l} ( {s}_{j}^{t + l} ) \cdot {c}_{0} , ∀ j \\ E [ {\hat{R}}_{R e j} ( {w}_{j}^{t + l} ) ] = 0 , ∀ j \\ {\hat{A}}^{t + l} = {\{ App , Rev , Rej \}}^{N ( t )} . \qquad ( 4 )$$

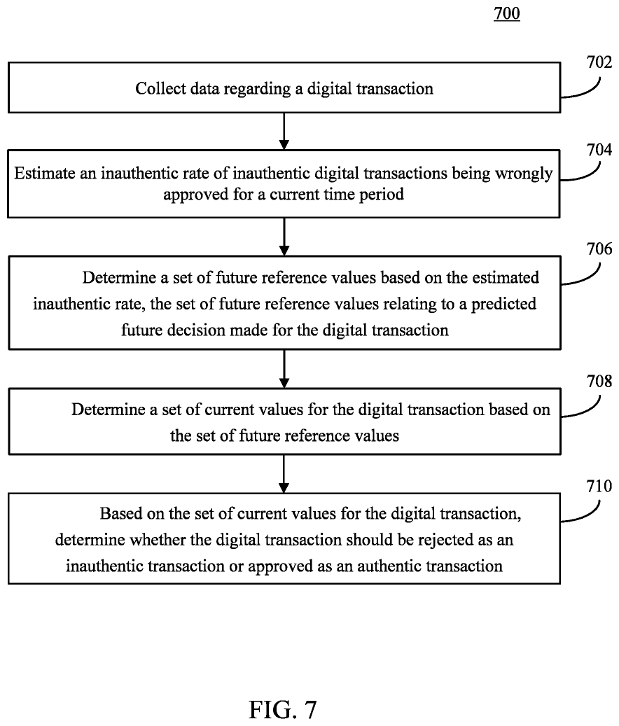

Further operational aspects of TMS 300, transaction control algorithm 400, and prospective control algorithm 500 will now be described in conjunction with FIG. 7, which depicts a flowchart 700 of a method for digital transaction management, according to an embodiment. Although described with reference to TMS 300 of FIG. 3, transaction control algorithm 400, and prospective control algorithm 500, the method of FIG. 7 is not limited to those implementations. Other structural and operation embodiments will be apparent to persons skilled in the relevant art(s) based on the following discussion.

Flowchart 700 is an example method for digital transactions management. Flowchart 700 begins at step 702. At step 702, data may be collected regarding a digital transaction. For example, and with reference to system 300 of FIG. 3, data collection component 306 may, as discussed above, collect data regarding the digital transaction, for example, features that may be any measurable characteristic of the transaction. Data collection component 306 may also be configured to collect other data such as user forensics, location, device forensics, and other data from databases and/or servers. In an embodiment, the digital transaction may be one of transactions 410 as shown in FIG. 4.

In step 704, an inauthentic rate of inauthentic digital transactions being wrongly approved for a current time period is estimated. For example, and with reference to system 300 of FIG. 3, transaction control component 308 may estimate a rate of inauthentic digital transactions being wrongly approved for a current time period. In an embodiment, this inauthentic rate may relate to a loss assumed by a merchant if the digital transactions for a particular time period is determined to be inauthentic. This inauthentic rate may also be referred to herein as the chargeback rate, \hat{ρ}_{CB}^{t}. For example, RGH 600 shown in FIG. 6 may be utilized to determine the inauthentic rate using equation 3 above.

In step 706, a set of future reference values based on the estimated inauthentic rate is determined, the set of future reference values relating to a predicted future decision made for the digital transaction is determined. For example, and with reference to system 300 of FIG. 3, transaction control component 308 may determine a set of future reference values or future reference rewards, Δ, based on the estimated inauthentic rate. In an example embodiment, the set of future reference rewards may be determined with RGH 600 shown in FIG. 6 and equation 4 above.

In step 708, a set of current values is determined for the digital transaction based on the set of future reference values. For example, and in reference to system 300 of FIG. 3, transaction control component 308 may determine a set of current values for the digital transaction based on the set of future reference values. The current values may include prospective rewards of the digital transaction for each possible decision of approve, reject or review. For example, for a transaction wⱼ^{τ} for each possible decision aⱼ^{τ} of approve, manual review or reject, the prospective rewards or profits may be determined by RGH 600 as follows:

\hat{R}ₐₚₚ^{F}(wⱼ^{τ}), \hat{R}ᵣₑᵥ^{F}(wⱼ^{τ}) & \hat{R}ᵣₑⱼ^{F}(wⱼ^{τ})

In step 710, based on the set of current values for the digital transaction, it is determined whether the digital transaction should be rejected as an inauthentic transaction or approved as an authentic transaction. For example, and in reference to reference to system 300 of FIG. 3, transaction control component 308 may determine whether the digital transaction is an inauthentic or authentic transaction. In embodiments, responsive to the determination whether a digital transaction is authentic or inauthentic, transaction control component 308 may take any number of actions, including modifying a security policy or rule, rejecting a transaction, approving a transaction, generating an alert, halting or terminating a transaction, cancelling a user account, flagging a transaction as authentic or inauthentic, or the like. In addition, transaction control strategies may be adjusted in real-time based on the control action taken.

The method of flowchart 700 may use the prospective control algorithm to manage digital transactions, although other methods may also be used. For example, one control algorithm that uses only mature data (e.g., data before period t−L) to estimate g functions may be utilized to aggressively reject transactions. Another control algorithm that uses mature data as well as partially mature data to estimate g functions may also be utilized to approve more authentic transactions and reject more inauthentic transactions than simply rejecting transactions aggressively.

In example embodiments, the method of flowchart 700 provides the same or similar benefits or technical improvements discussed above for TMS 300, control algorithm 400, prospective control algorithm 500, etc. Each of the steps of flowchart 700 may contribute to the overall technical improvement to the computing device(s) and/or system(s) on which it is implemented. For example, in determining whether the digital transaction should be rejected as an inauthentic transaction or approved as an authentic transaction, network efficiency gains, computing resources improvements may be made due to the enhanced decision accuracy of this step.

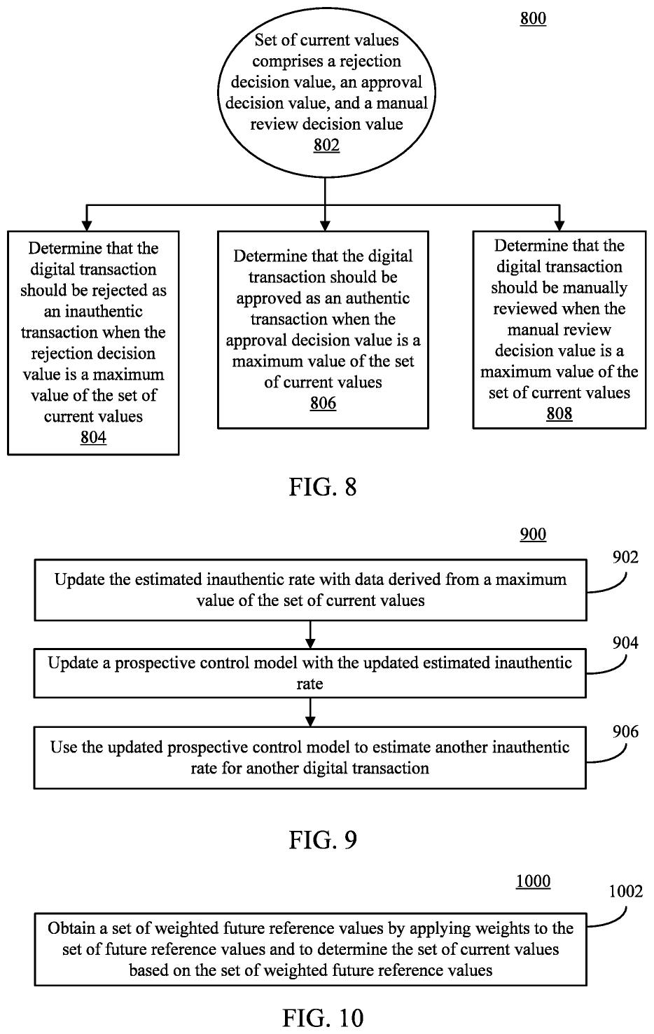

FIG. 8 depicts a flowchart 800 of a refinement to flowchart 700 of FIG. 7 for classifying a digital transaction, according to an example embodiment. Flowchart 800 begins at step 802. At step 802, a set of current values comprises a rejection decision value, an approval decision value, and a manual review decision value. For example, and with reference to TMS 300 of FIG. 3, transaction control component 308 may, as discussed above, use prospective control algorithm 500 to determine expected rewards for each control decision of approve, reject or manual review. The expected rewards may be referred to herein as current values. Thus, for a digital transaction, the current values may include a rejection decision value, an approval decision value, and a manual review decision value corresponding to the control decision of reject, approve and manual review, respectively. In an embodiment, the rejection decision value may be zero, as no reward or profit may be realized if no purchase is made. The approval decision value and manual review decision value may be any real number.

Flowchart 800 of FIG. 8 continues at step 804. In step 804, it is determined that the digital transaction should be rejected as an inauthentic transaction when the rejection decision value is a maximum value of the set of current values. For example, and with continued reference to TMS 300 of FIG. 3, transaction control component 308 may be configured to utilize prospective control algorithm 500 to determine whether the digital transaction should be rejected as an inauthentic transaction, in an embodiment. Transaction control component 308 may determine that the digital transaction should be rejected as an inauthentic transaction when the rejection decision value is a maximum value of the set of current values. For example, if the rejection decision yields the highest expected reward, then the digital transaction should be rejected as being inauthentic.

Flowchart 800 of FIG. 8 continues at step 806. In step 806, it is determined that the digital transaction should be approved as an authentic transaction when the approval decision value is a maximum value of the set of current values. For example, and with continued reference to TMS 300 of FIG. 3, transaction control component 308 may be configured to utilize prospective control algorithm 500 to determine whether the digital transaction should be approved as an authentic transaction, in an embodiment. Transaction control component 308 may determine that the digital transaction should be approved when the approval decision value is a maximum value of the set of current values. For example, if the approval decision yields the highest expected reward, then the digital transaction should be approved as being authentic.

Flowchart 800 of FIG. 8 ends at step 808. In step 808, it is determined that the digital transaction should be manually reviewed when the manual review value is a maximum value of the set of current values. For example, and with continued reference to TMS 300 of FIG. 3, transaction control component 308 may be configured to utilize prospective control algorithm 500 to determine whether the digital transaction should be manually reviewed, in an embodiment. Transaction control component 308 may determine that the digital transaction should be manually reviewed when the manual review decision value is a maximum value of the set of current values. For example, if the manual review decision yields the highest expected reward, then the digital transaction may be forwarded to the manual review team for further investigation.

Thus, for steps 804, 806 and 808 of flowchart 800, TMS 300 may determine a control decision for transaction wⱼ^{τ} using the equation below, where the decision that yields the maximum expected reward should be selected.

aⱼ*=argₐ_{ⱼ}_{^{τ}}_{∈{app,rev,rej}} max E(\hat{R}ₐ_{ⱼ}_{^{τ}}(wⱼ^{τ}))

FIG. 9 depicts a flowchart 900 of a refinement to the flowchart of FIG. 7 that includes a feedback loop for a transaction control model, according to an example embodiment. Flowchart 900 begins at step 902, in which the estimated inauthentic rate is updated with data derived from a maximum value of the set of current values. For example, and with continued reference to TMS 300 of FIG. 3, transaction control component 308 may be configured to update the estimated inauthentic rate. The estimated inauthentic rate may be updated based on a count of approval decisions, a count of manual review decisions, as well as the estimated g functions (e.g., g₂(s) and g₄(s) functions which are the probabilities of inauthentic transactions among the approved and reviewed decisions). These decisions may be based on or derived from the maximum expected reward. Since the maximum value corresponds to the control decision (approve, reject, or manual review) for the digital transaction, this step incorporates the decision for the current digital transaction in classifying subsequent transactions and/or determining control decisions for subsequent transactions.

Flowchart 900 continues with step 904, in which a prospective control model is updated with the updated estimated inauthentic rate. For example, and with continued reference to TMS 300 of FIG. 3, transaction control component 308 may be configured update the prospective control model as described above in reference to transaction control algorithm 400 of FIG. 4. In an embodiment, one or more prospective control models may be used while not all of them may be updated with the estimated inauthentic rate. For example, the modes or learning modules of FEI 408 may be updated but not CEI 406 as shown in FIG. 4. The estimated inauthentic rate may be updated in real-time, periodically (e.g., weekly), based on some triggering event or in any other manner.

Flowchart 900 ends with step 906, in which the updated prospective control model is used to estimate another inauthentic rate for another digital transaction. For example, and with continued reference to TMS 300 of FIG. 3, transaction control component 308 may be configured use the updated prospective control model to estimate another inauthentic rate for another, subsequent digital transaction. This inauthentic rate may be a rate of inauthentic digital transactions being wrongly approved for a given time period, for example, a time period during which the subsequent digital transaction occurs. For example, as shown in FIG. 4, during on-line decision process 404, updated g functions may be used for control determination of incoming digital transactions (e.g., transactions 410). The g functions may be updated based on the estimated inauthentic rate.

FIG. 10 depicts a flowchart 1000 of a refinement to the flowchart of FIG. 7 for determining a set of current values, according to an example embodiment. Flowchart 1000 includes step 1002, in which a set of weighted future reference values is obtained by applying weights to the set of future reference values and to determine the set of current values based on the set of weighted future reference values. For example, and with continued reference to TMS 300 of FIG. 3, transaction control component 308 may be configured to apply weights to the set of future reference values and to determine the set of current values based on the set of weighted future reference values. In an embodiment, transaction control component 308 may utilize RGH 600 to determine the referential future reward or profit, Δ, using equation 4 above. The current values may then be determined based on the weighted future reference values. The “referential future reward” may be referred to herein as “future reference values” and the “prospective rewards or profits” may be referred to herein as “current values.” For example, for transaction wⱼ^{t}, the expected reward of the approve, manual review or reject decisions may be respectively determined with the following equations.

$${R}_{app}^{F} ( {w}_{j}^{t} ) = E [ {\hat{R}}_{a p p} ( {w}_{j}^{t} ) ] + \frac{λ}{m} {Δ}_{a p p}$$

$${R}_{r e v}^{F} ( {w}_{j}^{t} ) = E [ {\hat{R}}_{r e ν} ( {w}_{j}^{t} ) ] + \frac{λ}{m} {Δ}_{r e v}$$

$${R}_{r e j}^{F} ( {w}_{j}^{t} ) = E [ {\hat{R}}_{r e j} ( {w}_{j}^{t} ) ] + \frac{λ}{m} {Δ}_{r e j}$$

The future reference values may first be averaged to reward per transaction and then weighted by a factor of λ. λ may server as a control parameter to account for business-specific detail such as market sensitivity, fluctuating currency, or events (e.g., Black Friday or holidays in which a surge in sales is expected).

In the foregoing discussion of flowcharts 700, 800, 900 and 1000, it should be understood that at times, any step of these flowcharts may be performed in a different order or even contemporaneously with other steps. Other operational embodiments will be apparent to persons skilled in the relevant art(s). Note also that the foregoing general description of the operation of TMS 300 is provided for illustration only, and embodiments of TMS 300 may comprise different hardware and/or software, and may operate in manners different than described above.

### III. EXAMPLE COMPUTER SYSTEM IMPLEMENTATION

Each of transaction management system 102, transaction management system 300, data collection component 306, transaction control component 308, CEI 406, FEI 408, CEI 502, FEI 504, and FEI 602, and flowcharts 700, 800, 900 and 1000 may be implemented in hardware, or hardware combined with software and/or firmware. For example, transaction management system 102, transaction management system 300, data collection component 306, transaction control component 308, CEI 406, FEI 408, CEI 502, FEI 504, and FEI 602, and flowcharts 700, 800, 900 and 1000 may be implemented as computer program code/instructions configured to be executed in one or more processors and stored in a computer readable storage medium. Alternatively, transaction management system 102, transaction management system 300, data collection component 306, transaction control component 308, CEI 406, FEI 408, CEI 502, FEI 504, and FEI 602, and flowcharts 700, 800, 900 and 1000 may be implemented as hardware logic/electrical circuitry.

For instance, in an embodiment, one or more, in any combination, of transaction management system 102, transaction management system 300, data collection component 306, transaction control component 308, CEI 406, FEI 408, CEI 502, FEI 504, and FEI 602, and flowcharts 700, 800, 900 and 1000 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

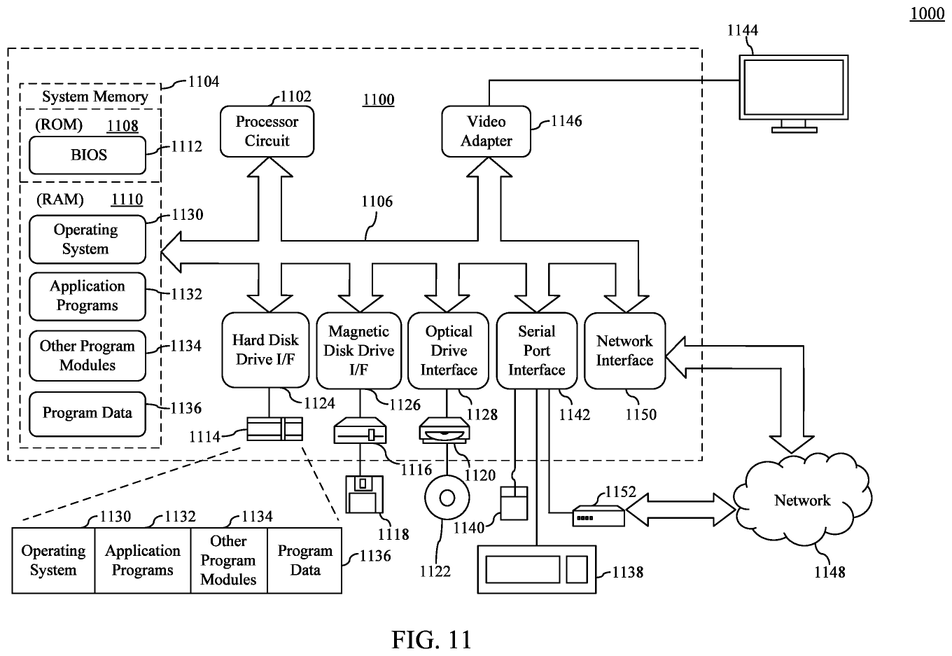

FIG. 11 depicts an exemplary implementation of a computing device 1100 in which embodiments may be implemented. For example, transaction management system 102, transaction management system 300, data collection component 306, transaction control component 308, CEI 406, FEI 408, CEI 502, FEI 504, and FEI 602 may each be implemented in one or more computing devices similar to computing device 1100 in stationary or mobile computer embodiments, including one or more features of computing device 1100 and/or alternative features. The description of computing device 1100 provided herein is provided for purposes of illustration, and is not intended to be limiting. Embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing transaction management system 102, transaction management system 300, data collection component 306, transaction control component 308, CEI 406, FEI 408, CEI 502, FEI 504, and FEI 602, and flowcharts 700, 800, 900 and 1000 (including any suitable step of such flowcharts), and/or further embodiments described herein.

A user may enter commands and information into the computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of embodiments described herein. Accordingly, such computer programs represent controllers of the computing device 1100.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. ADDITIONAL EXAMPLE EMBODIMENTS

A system for managing digital transactions over a network is described herein. The system comprises: a processing unit; and a memory device coupled to the processing unit, the memory device storing program instructions for execution by the processing unit, the program instructions comprising: a data collection component configured to collect data regarding a digital transaction; and a transaction control component configured to estimate an inauthentic rate of inauthentic digital transactions being wrongly approved for a current time period; determine a set of future reference values based on the estimated inauthentic rate, the set of future reference values relating to a predicted future decision made for the digital transaction; determine a set of current values for the digital transaction based on the set of future reference values; and based on the set of current values for the digital transaction, determine whether the digital transaction should be rejected as an inauthentic transaction or approved as an authentic transaction.

In an additional embodiment of the foregoing system, data regarding the digital transaction comprises one or more of a margin earned, a cost of goods, a cost of manual review, and a risk score.

In another embodiment of the foregoing system, the set of current values comprises a rejection decision value and an approval decision value, and the transaction control component is configured to determine that the digital transaction should be rejected as an inauthentic transaction when the rejection decision value is a maximum value of the set of current values; and determine that the digital transaction should be approved as an authentic transaction when the approval decision value is a maximum value of the set of current values.

In an additional embodiment of the foregoing system, the set of current values comprises a manual review decision value and the transaction control module is further configured to determine that the digital transaction should be manually reviewed when the manual review decision value is a maximum value of the set of current values.

In one embodiment of the foregoing system, the transaction control component is further configured to update the estimated inauthentic rate with data derived from a maximum value of the set of current values; update a prospective control model with the updated estimated inauthentic rate; and use the updated prospective control model to estimate another inauthentic rate for another digital transaction.

One embodiment of the foregoing system, the prospective control model comprises a machine learning model that is periodically trained with fully matured data associated with a first set of past digital transactions and partially matured data associated with a second set of past digital transactions that are more recent than the first set of past digital transactions.

In one embodiment of the foregoing system, the transaction control component is further configured to obtain a set of weighted future reference values by applying weights to the set of future reference values and to determine the set of current values based on the set of weighted future reference values.

A computer-implemented method is described herein. The method comprises collecting data regarding a digital transaction; estimating an inauthentic rate of inauthentic digital transactions being wrongly approved for a current time period; determining a set of future reference values based on the estimated inauthentic rate, the set of future reference values relating to a predicted future decision made for the digital transaction; determining a set of current values for the digital transaction based on the set of future reference values; and based on the set of current values for the digital transaction, determining whether the digital transaction should be rejected as an inauthentic transaction or approved as an authentic transaction.

In an additional embodiment of the foregoing method, the data regarding the digital transaction comprises one or more of a margin earned, a cost of goods, a cost of manual review, and a risk score.

In another embodiment of the foregoing method, the set of current values comprises a rejection decision value and an approval decision value, the method further comprises determining that the digital transaction should be rejected as an inauthentic transaction when the rejection decision value is a maximum value of the set of current values; and determining that the digital transaction should be approved as an authentic transaction when the approval decision value is a maximum value of the set of current values.

In yet another embodiment of the foregoing method, the set of current values further comprises a manual review decision value, the method further comprises determining that the digital transaction should be manually reviewed when the manual review decision value is a maximum value of the set of current values.

An additional embodiment of the foregoing method further comprises updating the estimated inauthentic rate with data derived from a maximum value of the set of current values; updating a prospective control model with the updated estimated inauthentic rate; and using the updated prospective control model to estimate another inauthentic rate for another digital transaction

In an additional embodiment of the foregoing method, the prospective control model comprises a machine learning model that is periodically trained with fully matured data associated with a first set of past digital transactions and partially matured data associated with a second set of past digital transactions that are more recent than the first set of past digital transactions.

Another embodiment of the foregoing method further comprises obtaining a set of weighted future reference values by applying weights to the set of future reference values and to determine the set of current values based on the set of weighted future reference values.

A computer program product comprising a computer-readable storage device having computer program logic recorded thereon that when executed by a processor-based computer system causes the processor-based system to perform a method, the method comprises: collecting data regarding a digital transaction; estimating an inauthentic rate of inauthentic digital transactions being wrongly approved for a current time period; determining a set of future reference values based on the estimated inauthentic rate, the set of future reference values relating to a predicted future decision made for the digital transaction; determining a set of current values for the digital transaction based on the set of future reference values; and based on the set of current values for the digital transaction, determining whether the digital transaction should be rejected as an inauthentic transaction or approved as an authentic transaction.

In another embodiment of the foregoing computer program product, the data regarding the digital transaction comprises one or more of a margin earned, a cost of goods, a cost of manual review, and a risk score.

In yet another embodiment of the foregoing computer program product, the set of current values comprises a rejection decision value and an approval decision value, the method further comprises determining that the digital transaction should be rejected as an inauthentic transaction when the rejection decision value is a maximum value of the set of current values; and determining that the digital transaction should be approved as an authentic transaction when the approval decision value is a maximum value of the set of current values.

In an additional embodiment of the foregoing computer program product, the set of current values further comprises a manual review decision value, the method further comprises determining that the digital transaction should be manually reviewed when the manual review decision value is a maximum value of the set of current values.

In another embodiment of the foregoing computer program product, the method further comprises updating the estimated inauthentic rate with data derived from a maximum value of the set of current values; updating a prospective control model with the updated estimated inauthentic rate; and using the updated prospective control model to estimate another inauthentic rate for another digital transaction

In yet another embodiment of the foregoing computer program product, the prospective control model comprises a machine learning model that is periodically trained with fully matured data associated with a first set of past digital transactions and partially matured data associated with a second set of past digital transactions that are more recent than the first set of past digital transactions.

### V. CONCLUSION

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A system for managing digital transactions over a network, comprising:
a processing unit; and
a memory device coupled to the processing unit, the memory device storing program instructions for execution by the processing unit, the program instructions comprising:
a data collection component configured to collect data regarding a digital transaction; and
a transaction control component configured to
estimate an inauthentic rate of inauthentic digital transactions being wrongly approved for a current time period;
determine a set of future reference values based on the estimated inauthentic rate, the set of future reference values relating to a predicted future decision made for the digital transaction;
determine a set of current values for the digital transaction based on the set of future reference values; and
based on the set of current values for the digital transaction, determine whether the digital transaction should be rejected as an inauthentic transaction or approved as an authentic transaction.

2. The system of claim 1, wherein the data regarding the digital transaction comprises one or more of a margin earned, a cost of goods, a cost of manual review, and a risk score.

3. The system of claim 1, wherein the set of current values comprises a rejection decision value and an approval decision value, and wherein the transaction control component is configured to
determine that the digital transaction should be rejected as an inauthentic transaction when the rejection decision value is a maximum value of the set of current values; and
determine that the digital transaction should be approved as an authentic transaction when the approval decision value is a maximum value of the set of current values.

4. The system of claim 3, wherein the set of current values further comprises a manual review decision value and wherein the transaction control module is further configured to determine that the digital transaction should be manually reviewed when the manual review decision value is a maximum value of the set of current values.

5. The system of claim 3, wherein the transaction control component is further configured to:
update the estimated inauthentic rate with data derived from a maximum value of the set of current values;
update a prospective control model with the updated estimated inauthentic rate; and
use the updated prospective control model to estimate another inauthentic rate for another digital transaction.

6. The system of claim 5, wherein the prospective control model comprises a machine learning model that is periodically trained with fully matured data associated with a first set of past digital transactions and partially matured data associated with a second set of past digital transactions that are more recent than the first set of past digital transactions.

7. The system of claim 1, wherein the transaction control component is configured to obtain a set of weighted future reference values by applying weights to the set of future reference values and to determine the set of current values based on the set of weighted future reference values.

8. A computer-implemented method, comprising:
collecting data regarding a digital transaction;
estimating an inauthentic rate of inauthentic digital transactions being wrongly approved for a current time period;
determining a set of future reference values based on the estimated inauthentic rate, the set of future reference values relating to a predicted future decision made for the digital transaction;
determining a set of current values for the digital transaction based on the set of future reference values; and
based on the set of current values for the digital transaction, determining whether the digital transaction should be rejected as an inauthentic transaction or approved as an authentic transaction.

9. The computer-implemented method of claim 8, wherein the data regarding the digital transaction comprises one or more of a margin earned, a cost of goods, a cost of manual review, and a risk score.

10. The computer-implemented method of claim 8, wherein the set of current values comprises a rejection decision value and an approval decision value, the method further comprising:
determining that the digital transaction should be rejected as an inauthentic transaction when the rejection decision value is a maximum value of the set of current values; and
determining that the digital transaction should be approved as an authentic transaction when the approval decision value is a maximum value of the set of current values.

11. The computer-implemented method of claim 10, wherein the set of current values further comprises a manual review decision value, the method further comprising:
determining that the digital transaction should be manually reviewed when the manual review decision value is a maximum value of the set of current values.

12. The computer-implemented method of claim 10, further comprising:
updating the estimated inauthentic rate with data derived from a maximum value of the set of current values;
updating a prospective control model with the updated estimated inauthentic rate; and
using the updated prospective control model to estimate another inauthentic rate another digital transaction

13. The computer-implemented method of claim 12, wherein the prospective control model comprises a machine learning model that is periodically trained with fully matured data associated with a first set of past digital transactions and partially matured data associated with a second set of past digital transactions that are more recent than the first set of past digital transactions.

14. The computer-implemented method of claim 8, further comprising:
obtaining a set of weighted future reference values by applying weights to the set of future reference values and to determine the set of current values based on the set of weighted future reference values.

15. A computer program product comprising a computer-readable storage device having computer program logic recorded thereon that when executed by a processor-based computer system causes the processor-based system to perform a method, the method comprising:
collecting data regarding a digital transaction;
estimating an inauthentic rate of inauthentic digital transactions being wrongly approved for a current time period;
determining a set of future reference values based on the estimated inauthentic rate, the set of future reference values relating to a predicted future decision made for the digital transaction;
determining a set of current values for the digital transaction based on the set of future reference values; and
based on the set of current values for the digital transaction, determining whether the digital transaction should be rejected as an inauthentic transaction or approved as an authentic transaction.

16. The computer program product of claim 15, wherein the data regarding the digital transaction comprises one or more of a margin earned, a cost of goods, a cost of manual review, and a risk score.

17. The computer program product of claim 15, wherein the set of current values comprises a rejection decision value and an approval decision value, the method further comprising:
determining that the digital transaction should be rejected as an inauthentic transaction when the rejection decision value is a maximum value of the set of current values; and
determining that the digital transaction should be approved as an authentic transaction when the approval decision value is a maximum value of the set of current values.

18. The computer program product of claim 17, wherein the set of current values further comprises a manual review decision value, the method further comprising:
determining that the digital transaction should be manually reviewed when the manual review decision value is a maximum value of the set of current values.

19. The computer program product of claim 17, wherein the method further comprises:
updating the estimated inauthentic rate with data derived from a maximum value of the set of current values;
updating a prospective control model with the updated estimated inauthentic rate; and
using the updated prospective control model to estimate another inauthentic rate for another digital transaction

20. The computer program product of claim 19, wherein the prospective control model comprises a machine learning model that is periodically trained with fully matured data associated with a first set of past digital transactions and partially matured data associated with a second set of past digital transactions that are more recent than the first set of past digital transactions.
